(19) United States
(12) Patent Application Publication
(10) Pub. No.: US 2008/0028132 A1
(43) Pub. Date: Jan. 31, 2008

(54) Non-volatile storage device, data storage system, and data storage method

(76) Inventors: Masanori Matsuura, Osaka (JP); Yasushi Gohou, Osaka (JP); Shunichi Iwanari, Kyoto (JP); Yoshiaki Nakao, Osaka (JP); Hisakazu Kotani, Hyogo (JP); Junichi Kato, Kyoto (JP); Satoshi Mishima, Hyogo (JP); Motonobu Nishimura, Kyoto (JP); Toshiki Mori, Osaka (JP)

Correspondence Address: MCDERMOTT WILL & EMERY LLP, 600 13TH STREET, NW, WASHINGTON, DC, 20005-3096, US

(21) Appl. No.: 11/798,679

(22) Filed: May 16, 2007

(30) Foreign Application Priority Data
Jul. 31, 2006 (JP) 2006-208552

(51) Int. Cl. G06F 12/00

(52) U.S. Cl. 711/103

(57) ABSTRACT

A non-volatile storage device comprises a non-volatile memory into which data is written per unit area, and a memory controller for controlling writing of data into the non-volatile memory. The memory controller comprises a first storage section for holding data input from the outside of the device, a first control section for writing data which is held by the first storage section and whose amount corresponds to the unit area, into the non-volatile memory in a unit area-by-unit area basis, and writing data which is held by the first storage section and whose amount is less than the unit area, into a second storage section, and a second control section for writing data held by the second storage section into the non-volatile memory.

### CROSS REFERENCE TO RELATED APPLICATION

This Non-provisional application claims priority under 35 U.S.C. §119(a) on Patent Application No. 2006-208552 filed in Japan on Jul. 31, 2006, the entire contents of which are hereby incorporated by reference.

### BACKGROUND OF THE INVENTION

1. Field of the Invention

The present invention relates to a non-volatile storage device comprising a rewriteable non-volatile memory, a data storage system comprising the non-volatile storage device, and a data storage method for writing data into the non-volatile memory.

2. Description of the Related Art

There is an increasing demand for non-volatile storage devices comprising rewriteable non-volatile main storage memories, such as, mainly, semiconductor memory cards. There are various types of semiconductor memory cards, including, for example, SD memory cards (registered trademark). The SD memory card comprises a flash memory as a non-volatile main storage memory, and also has a memory controller for controlling reading and writing of data with respect to the flash memory. The memory controller controls reading and writing of data with respect to the flash memory in response to read and write commands from an access apparatus, such as a digital still camera; a personal computer main body, or the like.

Such an SD memory card is loaded into an access apparatus, such as a personal computer or the like, and data in the SD memory card is managed using a FAT file system by a personal computer in a manner similar to that for data on other removable disks for data rewriting or the like.

In the FAT (File Allocation Tables) file system, when files or data are recorded into a recording device, a file allocation table (FAT) is used to issue data read and write commands. The data read and write commands are issued in units of, typically, “clusters”. The “cluster” is a unit including a plurality of “sectors” which are minimum units for data writing.

Conventionally, the size of a page (e.g., 512 bytes) which is a write unit for the flash memory included in the SD memory card, is the same as the size of the “sector”. However, in recent years, as higher capacity and higher speed of the flash memory are increasingly demanded, flash memories having a page size of 2 kilobytes, such as a multilevel NAND flash memory and the like, are becoming mainstream.

An exemplary operation will now be described when, in an SD memory card having a page size of 4 sectors, a sector of data at a logical sector number (logical address) 0 is rewritten. It is here assumed that four sectors of data are already written at logical sector numbers (addresses) 0 to 3 in the flash memory. Initially, a sector of update data at logical sector number (address) 0 is newly written into a leading page of an erased physical block. Meanwhile, three sectors of data which are already written in the flash memory are read from logical sector numbers (addresses) 1 to 3. The three sectors of data thus read are written together with the sector of update data at logical sector number (address) 0 into a free area of the leading page. The process of reading and writing data which is not to be rewritten (in the example above, the three sectors of data at logical sector numbers (addresses) 1 to 3) is hereinafter referred to as a save process.

Such are write process technique is disclosed in U.S. Pat. No. 6,760,805. However, in the rewrite technique with the save process, when data whose amount is less than one page (e.g., one sector of data, etc.) is rewritten, it is necessary to read and write old data, resulting in a complicated and time-consuming process.

A technique for addressing such a problem is disclosed in, for example, Japanese Unexamined Patent Application Publication No. 5-27924. Note that, in an external storage system disclosed in Japanese Unexamined Patent Application Publication No. 5-27924, a non-volatile RAM is used rather than a buffer (SRAM).

In a flash memory of the external storage system disclosed in Japanese Unexamined Patent Application Publication No. 5-27924, sectors in a physical block are not arranged in logical order, and instead, data is written from a lower page of a physical block in order of issuance of a write command (the oldest first). It is determined on a page-by-page basis whether written data is valid data or invalid old data, thereby managing a record status.

Thus, in the external storage system of Japanese Unexamined Patent Application Publication No. 5-27924, the data save process is not carried out, so that writing itself is executed with relatively high speed. However, it is necessary to execute garbage collection (only a valid sector(s) is collected from a predetermined block and is written and copied to another erased block, and the invalid block is erased) with predetermined timing.

Also, a technique for efficiently writing data in units less than or equal to pages in a non-volatile memory in which writing is executed in units of pages as described above, is disclosed in, for example, Japanese Unexamined Patent Application Publication No. 2002-123430.

In a data processing apparatus disclosed in Japanese Unexamined Patent Application Publication No. 2002-123430, update data for a non-volatile memory in which writing is executed in units of pages is temporarily stored together with an address at which the update data is stored, into a first temporary storage means. Thereafter, when new update data is input from the outside of the apparatus, it is determined whether or-not update data having an address corresponding to the address of the new update data is present in the update data stored in the first temporary storage means. When the result of the determination is positive, the update data having the corresponding address of the first temporary storage means is rewritten with the new update data. When the result of the determination is negative, and it is also determined that the number of pieces of update data in the first temporary storage means has reached a predetermined number, all stored data in each page to be processed is read and transferred from the non-volatile memory to a second temporary storage means. After the whole or a part of data in the second temporary storage means is updated with the update data in the first temporary storage means, the data in the second temporary storage means is written back into the non-volatile memory.

As described above, in the data processing apparatus of Japanese Unexamined Patent Application Publication No. 2002-123430, writing is not executed with respect to the non-volatile memory, until the number of pieces of data stored in the first temporary storage means reaches a predetermined number. Therefore, when data to be stored into a predetermined page of the non-volatile memory is divided into a plurality of continuous portions, which are then sequentially input, the predetermined page of data is accumulated in the first temporary storage means. After the full predetermined page of data is stored in the first temporary storage means, the data is simultaneously written into the non-volatile memory. Therefore, when a page of data is divided into a plurality of continuous portions, which are then sequentially input, the number of times of writing to the non-volatile memory is smaller than when data is written into the non-volatile memory every time the data is input. Therefore, the number of times of the save process is also reduced.

### SUMMARY OF THE INVENTION

However, in the external storage system of Japanese Unexamined Patent Application Publication No. 5-27924, the garbage collection process requires a relatively long time. Therefore, in view of the time spent for the garbage collection process, the average performance of the external storage system during data writing is considered not to be high.

Also, in the external storage system of Japanese Unexamined Patent Application Publication No. 2002-123430, when a portion of a predetermined page of data is input to the data processing apparatus before a large amount of continuous data, such as music data, image data, or the like, is input, the number of pieces of data in the first temporary storage means reaches a predetermined number due to the input of the large amount of data, and the previously input data portion is written into the non-volatile memory. Thereafter, the remaining data in the predetermined page is input to the data processing apparatus. In this case, consequently, the number of times of writing is plural in order to write the predetermined page of data into the non-volatile memory, so that it takes a long time to write data into the non-volatile memory, resulting in poor efficiency.

If the first temporary storage means has a large capacity which can temporarily hold a large amount of continuous data, data can be quickly and efficiently written. However, the cost of the device is increased with an increase in the capacity of the memory.

Therefore, in view of the above-described problems, an object of the present invention is to provide a non-volatile storage device into which data can be written with high speed.

To achieve the object, a first embodiment of the present invention is a non-volatile storage device comprising a non-volatile memory into which data is written per unit area, and a memory controller for controlling writing of data into the non-volatile memory. The memory controller comprises a first storage section for holding data input from the outside of the device, a first control section for writing data which is held by the first storage section and whose amount corresponds to the unit area, into the non-volatile memory in a unit area-by-unit area basis, and writing data which is held by the first storage section and whose amount is less than the unit area, into a second storage section, and a second control section for writing data held by the second storage section into the non-volatile memory.

Thereby, data which has been accumulated in the first storage section in an amount corresponding to the unit area is directly written into the non-volatile memory, while data whose amount has not reached the unit area is written into the second storage section before being written into the non-volatile memory. Even when a large amount of continuous data including data whose amount corresponds to at least one unit area is input, data whose amount has reached the unit area is written into the non-volatile memory, and only data whose amount has not reached the unit area is written into the second storage section.

A second embodiment of the present invention is the non-volatile storage device of the first embodiment, in which the first control section, when data input from the outside of the device, following data which is previously held by the first storage section and whose amount corresponds to the unit area, is continuous to the previous data, writes the previous data into the non-volatile memory, and when the following data is not continuous to the previous data, writes the previous data into the second storage section.

Thereby, data which has been accumulated in the first storage section in an amount corresponding to the unit area is directly written into the non-volatile memory when it is continuous to data which is next input from the outside of the device, and when otherwise, is written into the second storage section before being written into the non-volatile memory.

A third embodiment of the present invention is the non-volatile storage device of the first embodiment, in which the first control section, when a signal indicating the end of predetermined data transfer is input from the outside of the device immediately after data which is held by the first storage section and whose amount corresponds to the unit area is input from the outside of the device, writes the data whose amount corresponds to the unit area into the second storage section.

Thereby, data which has been accumulated in the first storage section in an amount corresponding to the unit area is directly written into the non-volatile memory when other data is input, following the input of that data into the device, and is written into the second storage section before being written into the non-volatile memory when a signal indicating the end of data transfer immediately after that data is input to the device.

A fourth embodiment of the present invention is the non-volatile storage device of the first embodiment, further comprising an address history management section for storing a history of a logical address of data input from the outside of the device. The first control section determines whether or not there is a possibility that data which is held by the first storage section and whose amount corresponds to the unit area is to be rewritten, based on the logical address stored in the address history management section. The first control section writes the data whose amount corresponds to the unit area into the non-volatile memory when determining that there is not the possibility, and into the second storage section when determining that there is the possibility.

Thereby, data which has been accumulated in the first storage section in an amount corresponding to the unit area is directly written into the non-volatile memory when it is determined that there is not the possibility, and is written into the second storage section before being written into the non-volatile memory when it is determined that there is not the possibility. Therefore, the device can be easily configured so that data which is frequently rewritten is held by the second storage section, so that the data is updated in the second storage section, and the data is written from the second storage section into the non-volatile memory with certain particular timing.

A fifth embodiment of the present invention is the non-volatile storage device of the first embodiment, in which, when data whose amount corresponds to the unit area is held by the second storage section, the second control section writes the data whose amount corresponds to the unit area into the non-volatile memory.

Thereby, every time data is accumulated in the second storage section in an amount corresponding to the unit area, the accumulated data is written into the non-volatile memory, so that the number of times of writing of data into the non-volatile memory is reduced.

A sixth embodiment of the present invention is the non-volatile storage device of the first embodiment, in which, when data whose amount corresponds to the unit area is previously held by the second storage section and a logical address of data input from the outside of the device, following the previous data, is continuous to a logical address of the previous data, the second control section writes the previous data into the non-volatile memory.

Thereby, data which has been accumulated in the second storage section in an amount corresponding to the unit area is written into the non-volatile memory when the logical address of data input from the outside of the device, following that data, is continuous to the logical address of that data.

A seventh embodiment of the present invention is the non-volatile storage device of the first embodiment, in which, when data whose amount is larger than or equal to a predetermined amount is held by the second storage section, the second control section writes data held by the second storage section into the non-volatile memory.

Thereby, a free area for holding data to be written from the first storage section to the second storage section is secured.

An eighth embodiment of the present invention is the non-volatile storage device of the first embodiment, in which, when data has not been input from the outside of the device for a predetermined period of time, the second control section writes data held by the second storage section into the non-volatile memory.

Thereby, when data has not been input from the outside of the device for a predetermined period of time, data held by the second storage section is written into the non-volatile memory.

A ninth embodiment of the present invention is the non-volatile storage device of the first embodiment, in which, when data having the same logical address as that of write data to be written into the second storage section is held by the second storage section, the first control section overwrites the data having the same logical address with the write data.

Thereby, in the second storage section, data having the same logical address as that of write data to be written from the first storage section into the second storage section is overwritten with the write data, so that the area of the second storage section is effectively utilized, and therefore, the number of times of writing from the second storage section to the non-volatile memory is reduced.

A tenth embodiment of the present invention the non-volatile storage device of the first embodiment, in which, when a plurality of pieces of data having the same logical address as that of write data to be written into the second storage section are held by the second storage section, the first control section overwrites an oldest one of the plurality of pieces of data having the same logical address with the write data.

Thereby, when a plurality of pieces of data having the same logical address as that of write data are held by the second storage section, the oldest one of the plurality of pieces of data having the same logical address is overwritten with the write data, and the data other than the oldest data remains held by the second storage section.

An eleventh embodiment of the present invention is the non-volatile storage device of the first embodiment, in which the first control section writes data which is held by the first storage section and whose amount corresponds to the unit area, into the non-volatile memory and the second storage section, depending on the level of importance of the data whose amount corresponds to the unit area.

Thereby, important data is saved into both the second storage section and the non-volatile memory, so that the possibility that data is destroyed due to interruption of power supply during writing or the like, is reduced, resulting in an increase in reliability of the device and a system comprising the device.

A twelfth aspect of the present invention is the non-volatile storage device of the first embodiment, further comprising a read control section for transferring data in the non-volatile memory to the first storage section without via the second storage section, and causing the first storage section to temporarily hold the data before being output to the outside of the device, in response to a data read request from the outside of the device.

Thereby, writing of data into the second storage section is not executed during reading, resulting in a reduction in the number of times of rewriting of data.

A thirteenth embodiment of the present invention is the non-volatile storage device of the first embodiment, in which the second storage section is a non-volatile RAM.

A fourteenth embodiment of the present invention is the non-volatile storage device of the thirteenth embodiment, in which the second storage section includes any one of a ferroelectric random access memory, a magnetoresistive random access memory, an ovonic unified memory, and a resistance random access memory.

Thereby, the second storage section can be easily constructed.

### BRIEF DESCRIPTION OF THE DRAWINGS

FIG. 1 is a block diagram illustrating a configuration of a data storage system according to Embodiment 1 of the present invention.

FIG. 2 is a diagram for describing a format of each physical block of a non-volatile memory 130 of Embodiment 1.

FIG. 3 is a diagram for describing a format of a second storage section 123 of Embodiment 1.

FIG. 4 is a flowchart illustrating a write operation of a non-volatile storage device 100 of Embodiment 1.

FIG. 5 is a flowchart illustrating a write operation of the non-volatile storage device 100 of Embodiment 1.

FIG. 6 is a diagram for describing an exemplary write process executed by the non-volatile storage device 100 of Embodiment 1.

FIG. 7 is a flowchart illustrating a write operation of a non-volatile storage device 100 according to Embodiment 2.

FIG. 8 is a flowchart illustrating a write operation of the non-volatile storage device 100 of Embodiment 2.

FIG. 9 is a diagram for describing an exemplary write process executed by the non-volatile storage device 100 of Embodiment 2.

FIG. 10 is a flowchart illustrating a write operation of a non-volatile storage device 100 according to Embodiment 3.

FIG. 11 is a flowchart illustrating a write operation of a non-volatile storage device 100 according to Embodiment 4.

FIG. 12 is a flowchart illustrating a write operation of a non-volatile storage device 100 according to Embodiment 5.

FIG. 13 is a flowchart illustrating a write operation of a non-volatile storage device 100 according to Embodiment 6.

FIG. 14 is a diagram for describing an exemplary write process executed by a conventional data processing apparatus comprising a non-volatile memory.

FIG. 15 is a diagram for describing an exemplary write process executed by a conventional data processing apparatus comprising a non-volatile memory.

### DETAILED DESCRIPTION OF THE PREFERRED EMBODIMENTS

Hereinafter, embodiments of the present invention will be described with reference to the accompanying drawings. Note that like parts are indicated with like reference numerals throughout the specification and will not be repeatedly described.

### Embodiment 1

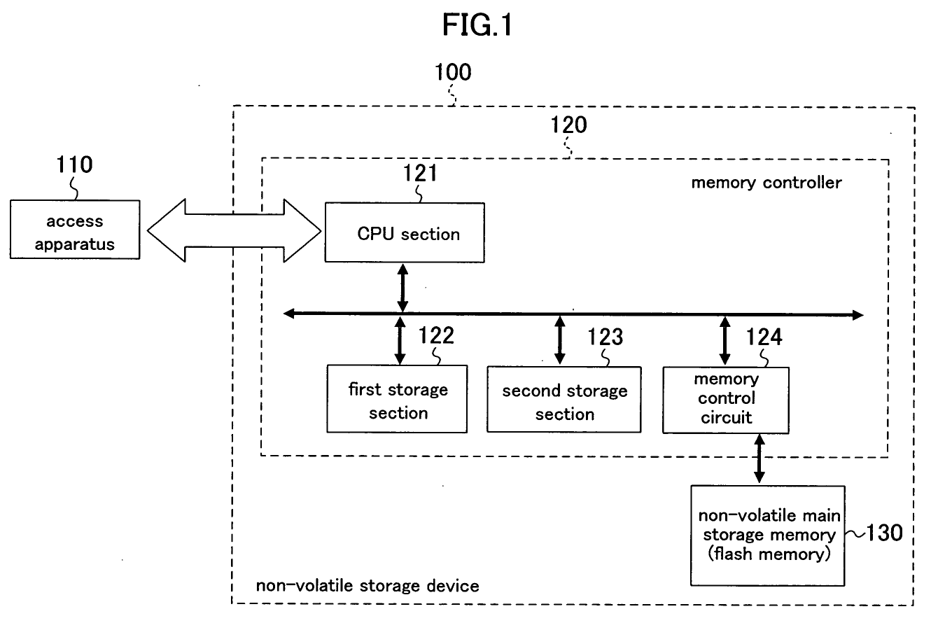

FIG. 1 is a block diagram illustrating a configuration of a data storage system according to Embodiment 1 of the present invention. The data storage system comprises a non-volatile storage device 100 and an access apparatus 110. The non-volatile storage device 100 is connected to the access apparatus 110.

As illustrated in FIG. 1, the non-volatile storage device 100 comprises a memory controller 120 and a non-volatile memory 130 including a flash memory.

The access apparatus 110 is provided external to the non-volatile storage device 100 and accesses the non-volatile storage device 100. More specifically, the access apparatus 110 transmits a command to read or write user data (hereinafter referred to as “data”), transmits a logical address at which the data is stored, and transmits and receives data via the memory controller 120 to or from the non-volatile memory 130. The access apparatus 110 is a main computer, an in-vehicle terminal, or the like.

The memory controller 120 controls reading and writing of data with respect to the non-volatile memory 130. More specifically, the memory controller 120 receives a read or write command from the access apparatus 110, and writes received data to the non-volatile memory 130 or reads data from the non-volatile memory 130 and outputs the data to the outside.

Next, a configuration of the memory controller 120 will be described in detail.

As illustrated in FIG. 1, the memory controller 120 comprises a CPU section 121, a first storage section 122, a second storage section 123, and a memory control circuit 124.

The first storage section 122 temporarily holds (stores) data which has been input from the access apparatus 110 to the non-volatile storage device 100, before the data is written into the non-volatile memory 130.

The second storage section 123 holds (stores) a portion of the data held by the first storage section 122.

The memory control circuit 124 controls the non-volatile memory 130.

The CPU section 121 (a first control section and a second control section) controls communication of information between the memory controller 120 and the outside, including, for example, transmission and reception of data to and from the access apparatus 110 and management of addresses during reading and writing of data from and to the non-volatile memory 130. The CPU section 121 also controls the first storage section 122 and the second storage section 123, and also controls writing (storage) of data held (stored) in the first storage section 122 to the second storage section 123 and the non-volatile memory 130, for example.

Note that an address management process executed by the CPU section 121, i.e., for example, a process of converting a logical address designated by the access apparatus 110 into a physical address of the non-volatile memory 130, is generally known, and will not be described.

The first storage section 122 and the second storage section 123 each comprise a volatile memory (e.g., a Static Random Access Memory (SRAM), etc.) or a non-volatile memory (e.g., a Ferro-Electric Random Access Memory (FeRAM), a Magnetoresistive Random Access Memory (MRAM), an Ovonic Unified Memory (OUM), a Resistance Random Access Memory (RRAM), etc.).

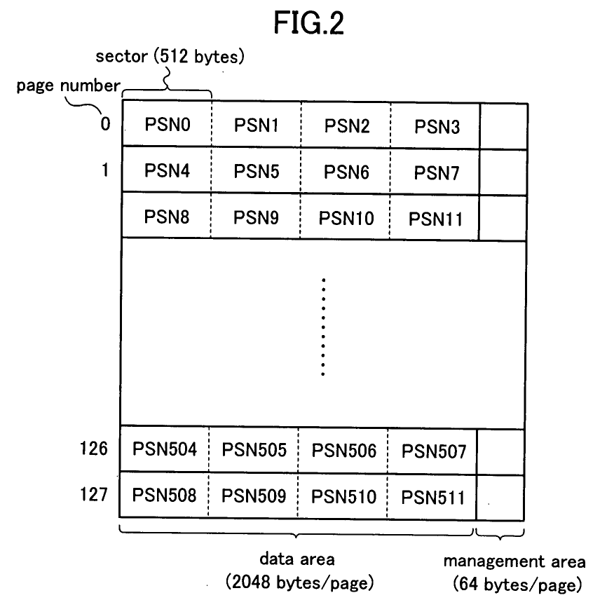

In the non-volatile memory 130, a plurality of storage areas called physical blocks are provided. FIG. 2 is a diagram for describing a format of each physical block.

As illustrated in FIG. 2, each physical block is composed of 128 pages. Each page is composed of four sectors of data area and a management area. In this embodiment, the data amount of a sector is 512 bytes. Therefore, the data amount of the data area of each page is four sectors, i.e., 2048 bytes. Note that the management area is an area for storing information required for the CPU section 121 to execute an address management process. Here, in FIG. 2, sectors are assigned location symbols, such as PSN0, PSN1, . . . , and PSN511, started from the upper left corner. The PSN is a Physical Sector Number corresponding to a sector. In the non-volatile memory 130, data is written in units of pages (unit areas).

The non-volatile storage device 100 is also configured so that, when the access apparatus 110 reads data from the non-volatile memory 130, the data in the non-volatile memory 130 is directly transferred to the first storage section 122 and is output to the access apparatus 110. More specifically, the non-volatile storage device 100 comprises a read control section which, in response to a data read request externally input, transfers the data in the non-volatile memory 130 to the first storage section 122 without via the second storage section 123, causes the first storage section 122 to temporarily hold the data, and thereafter, outputs the data to the outside of the device.

With the configuration as described above, based on a physical address designated by the CPU section 121 or a write condition, data is written into the non-volatile memory 130 or the second storage section 123 and data is read from the non-volatile memory 130 or the second storage section 123.

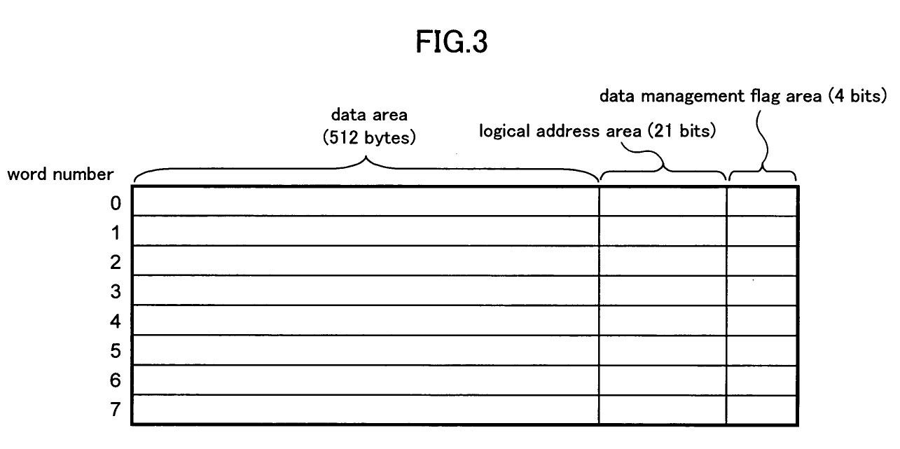

FIG. 3 is a diagram for describing a format of the second storage section 123.

As illustrated in FIG. 3, the storage area of the second storage section 123 is divided into eight words. Each word is divided into a data area, a logical address area, and a data management flag area. The logical address area of each word has a capacity having a predetermined number of bits (21 bits) which can identify sectors corresponding to 1 GBytes. In each word, the data area holds data whose amount corresponds to a sector of a physical block, and the logical address area holds a logical address of the sector of data stored in the data area. Also, the data management flag area stores a flag indicating which word holds latest data in the data area when a plurality of sectors of data having the same logical address are stored in the second storage section 123, and a value indicating whether the data area of each word can store new data. A state in which the data area can store new data refers to, for example, a state after data held in the data area is transferred to the non-volatile memory 130 and until new data is then written into the data area.

Although it is here described that the second storage section 123 is divided into eight words, the capacity of the second storage section 123 is not limited to this. Also, when write data less than one page is written from the second storage section 123 to the non-volatile memory 130, remaining data already stored in a page corresponding to the write data may be temporarily written from the non-volatile memory 130 to the second storage section 123. Thereby, when data is written from the second storage section 123 to the non-volatile memory 130, the second storage section 123 can hold data in units of pages. In this case, the number of pages in the second storage section 123 is not limited.

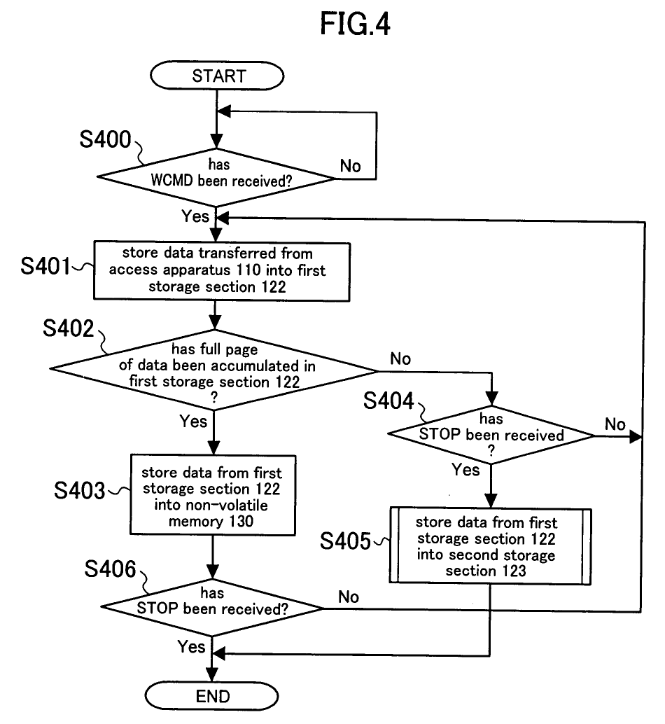

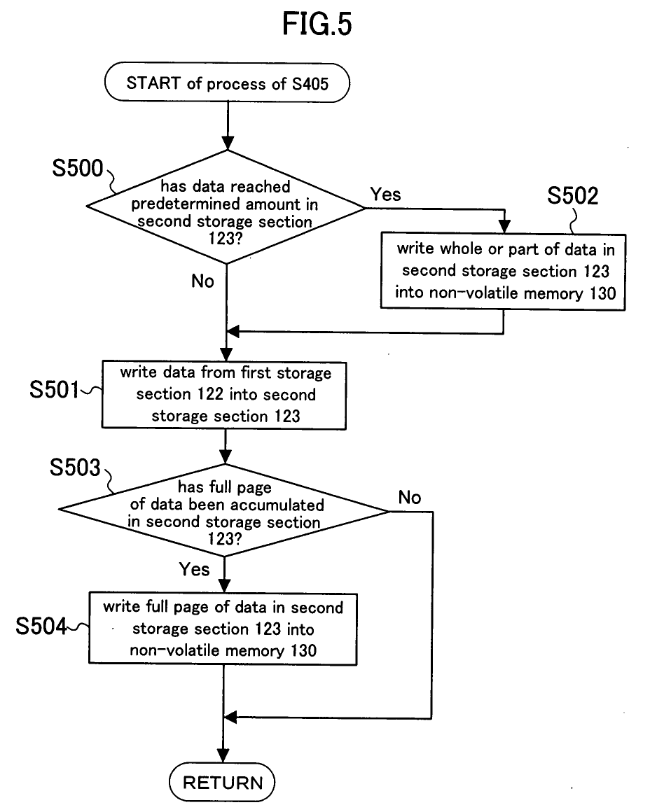

Next, an operation of the thus-configured non-volatile storage device 100 of this embodiment will be described with reference to FIGS. 4 and 5. By a series of write operations of the non-volatile storage device 100 illustrated in FIGS. 4 and 5, data which is transferred from the access apparatus 110 to the non-volatile storage device 100 is temporarily held in the first storage section 122, and thereafter, temporarily held data is written into the non-volatile memory 130, via the second storage section 123 or directly. (S400) The non-volatile storage device 100 goes to a state in which it waits for a data write command (hereinafter referred to as a WCMD) from the access apparatus 110. When receiving the WCMD from the access apparatus 110, the non-volatile storage device 100 goes to a process of (S401).

(S401) When a sector of data and the logical address of the data are transferred (transmitted) from the access apparatus 110, the CPU section 121 stores a value of the transferred logical address into a register of the CPU section 121, and writes the data into the first storage section 122.

(S402) The CPU section 121 determines whether or not the amount of data to be stored into the same page of the non-volatile memory 130, which is accumulated in the first storage section 122, has reached a full page. If the result of the determination is positive, the non-volatile storage device 100 goes to a process of (S403). If the result of the determination is negative, the non-volatile storage device 100 goes to a process of (S404).

(S403) The CPU section 121 writes the full page of data accumulated in the first storage section 122 into a one-page area of a predetermined physical block of the non-volatile memory 130.

(S404) The CPU section 121 determines whether or not a STOP signal indicating the end of data transfer has been input from the access apparatus 110 to the non-volatile storage device 100. When the result of the determination is positive, the non-volatile storage device 100 goes to a process of (S405) ((S500)). When the result of the determination is negative, the non-volatile storage device 100 returns to the process of (S401).

(S405) The CPU section 121 writes all data held by the first storage section 122 into the second storage section 123.

(S406) The CPU section 121 determines whether or not a STOP signal has been input from the access apparatus 110 to the non-volatile storage device 100. When the result of the determination is positive, the non-volatile storage device 100 ends the write process. When the result of the determination is negative, the non-volatile storage device 100 returns to the process of (S401).

When the non-volatile storage device 100 receives a plurality of sectors of data after receiving a WCMD and until receiving a STOP signal, the processes of (S401) to (S403) and the determinations of (S404) and (S406) are repeated every time a sector of data is received, until the STOP signal is received.

Next, the process of (S405) will be described in detail with reference to FIG. 5.

(S500) The CPU section 121 determines whether or not the data amount of the second storage section 123 has reached a predetermined amount. When the result of the determination is negative, the non-volatile storage device 100 goes to a process of (S501). When the result of the determination is positive, the non-volatile storage device 100 goes to a process of (S502). Here, the predetermined amount is, for example, an amount obtained by subtracting an amount corresponding to a page of data from the capacity of the second storage section 123.

(S501) The CPU section 121 writes all data in the first storage section 122 into the second storage section 123.

(S502) The CPU section 121 writes the whole or a part of data in the second storage section 123 into the non-volatile memory 130.

(S503) The CPU section 121 determines whether or not the amount of data to be stored into the same page of the non-volatile memory 130, which is accumulated in the second storage section 123, has reached a full page. If the result of the determination is positive, the non-volatile storage device 100 goes to a process of (S504). If the result of the determination is negative, the non-volatile storage device 100 ends the write process.

(S504) The CPU section 121 writes the full page of data accumulated in the second storage section 123 into the non-volatile memory 130, and ends the write process.

Note that the second storage section 123 may be comprised of a non-volatile memory (e.g., an FeRAM, etc.) or a volatile memory to which stable power is invariably supplied. In this case, when data is stored in the second storage section 123 in (S405), the access apparatus 110 may be notified of completion of the write process, via the CPU section 121.

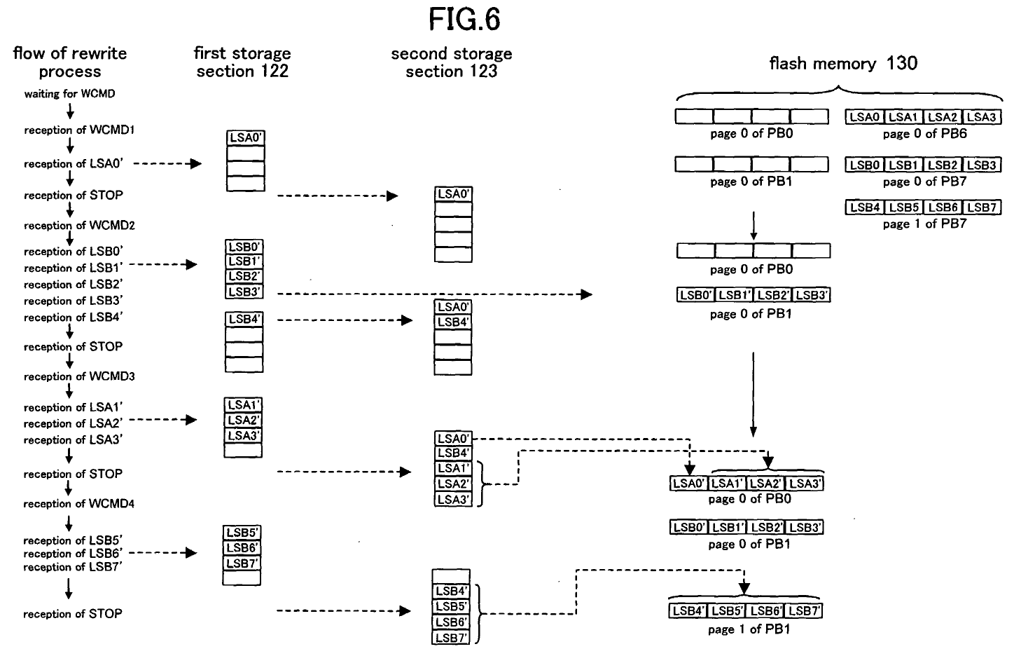

Next, an exemplary process executed by the non-volatile storage device 100 of this embodiment will be described with reference to FIG. 6.

In the example of FIG. 6, the first storage section 122 holds a page of data (four sectors of data) of the non-volatile memory 130, and the second storage section 123 holds five sectors of data, and a WCMD is transferred from the access apparatus 110 four times. The first WCMD is represented by WCMD1, the next WCMD is represented by WCMD2, the still next WCMD is represented by WCMD3, and the final WCMD is represented by WCMD4. It is assumed that, when the non-volatile storage device 100 receives WCMD1, old data LSA0 to LSA3 are already stored in page 0 of a physical block PB6 of the non-volatile memory 130, old data LSB0 to LSB3 are already stored in page 0 of a physical block PB7, and old data LSB4 to LSB7 are already stored in page 1 of the physical block PB7. It is also assumed that new data LSA0′ to LSA3′ which are transferred from the access apparatus 110 are written into page 0 of a physical block PB0, and similarly, new data LSB0′ to LSB7′ having different write addresses which are transferred from the access apparatus 110 are written into page 0 and page 1 of a physical block PB1. The physical blocks PB0 and PB1 are erased, or changed into a state in which new data can be written after old data is erased, by the time when the new data LSA0′ to LSA3′ or LSB0′ to LSB7′ are written.

As illustrated in FIG. 6, after receiving WCMD1, the non-volatile storage device 100 receives data (LSA0′) having a logical sector number 0, and causes the first storage section 122 to temporarily hold the data. Next, when the non-volatile storage device 100 receives a STOP signal, the CPU section 121 writes the data LSA0′ held in the first storage section 122 together with address information (e.g., a logical address, etc.) to the second storage section 123.

Next, WCMD2 and the data LSB0′ to LSB4′ are transferred (transmitted) to the non-volatile storage device 100 by the access apparatus 110. When data LSB0′ to LSB3′ are held in the first storage section 122, the CPU section 121 determines that data to be stored into the same page of the non-volatile memory 130, which is accumulated in the first storage section 122, has reached a full page. Immediately after the determination, the CPU section 121 writes the data held by the first storage section 122 into page 0 of the physical block PB1 of the non-volatile memory 130. Thereafter, when the non-volatile storage device 100 receives data LSB4′, the CPU section 121 causes the first storage section 122 to temporarily hold the data. Next, when a STOP signal is input to the non-volatile storage device 100, the CPU section 121 writes data LSB4′ into the second storage section 123, and the non-volatile storage device 100 ends the write process.

Next, when the non-volatile storage device 100 receives WCMD3 and the data LSA1′ to LSA3′, these pieces of data are temporarily held in the first storage section 122. Thereafter, when the non-volatile storage device 100 receives a STOP signal, the CPU section 121 writes the data LSA1′ to LSA3′ into the second storage section 123. Thereby, the data LSA0′ to LSA3′, i.e., data to be stored into the same page of the non-volatile memory 130, which is accumulated in the second storage section 123, reaches a full page. Therefore, the CPU section 121 writes data LSA0′ to LSA3′ into page 0 of the physical block PB0 of the non-volatile memory 130.

Finally, when the non-volatile storage device 100 receives WCMD4 and the data LSB5′ to LSB7′, these pieces of data are temporarily held in the first storage section 122. Thereafter, when the non-volatile storage device 100 receives a STOP signal, the CPU section 121 writes the data LSB5′ to LSB7′ into the second storage section 123. Thereby, the data LSB4′ to LSB7′, i.e., data to be stored into the same page of the non-volatile memory 130, which is accumulated in the second storage section 123, reaches a full page. Therefore, the CPU section 121 writes these pieces of data into page 1 of the physical block PB1 of the non-volatile memory 130.

In this embodiment and the following embodiments, the CPU section 121, when writing data from the first storage section 122 into the second storage section 123, causes the second storage section 123 to hold the data, and invalidates data which remains in the first storage section 122 after being written into the second storage section 123, though this has not been described above. Similarly, when data is written from the second storage section 123 into the non-volatile memory 130, the data is written into the non-volatile memory 130, and the write data remaining in the second storage section 123 is invalidated. For example, in the example of FIG. 6, when the CPU section 121 writes the data LSA0′ to LSA3′ held in the second storage section 123 into page 0 of the physical block PB0 of the non-volatile memory 130, the data LSA0′ to LSA3′ held in the second storage section 123 are invalidated.

The new data LSA0′ to LSA3′ and LSB0′ to LSB7′ are simultaneously written into page 0 of the physical block PB0 and page 0 or page 1 of the physical block PB1, respectively. Therefore, the save process of old data, i.e., a process of reading and then writing old data, is no longer required. Old data stored in page 0 of the physical block PB6 and pages 0 and 1 of the physical block PB7 are erased with certain appropriate timing.

Although the save process is not executed in the example of FIG. 6, the non-volatile storage device may be configured so that data is written from the second storage section 123 into the non-volatile memory 130 by the save process. In this case, the old data LSA0 to LSA3 and LSB0 to LSB7 are read from page 0 of the physical block PB6 and pages 0 and 1 of the physical block PB7 and are stored into a save storage section (not shown), and the old data is overwritten with the new data LSA0′ to LSA3′ and LSB0′ to LSB7′ in the save storage section, and the data in the save storage section is written into the non-volatile memory 130.

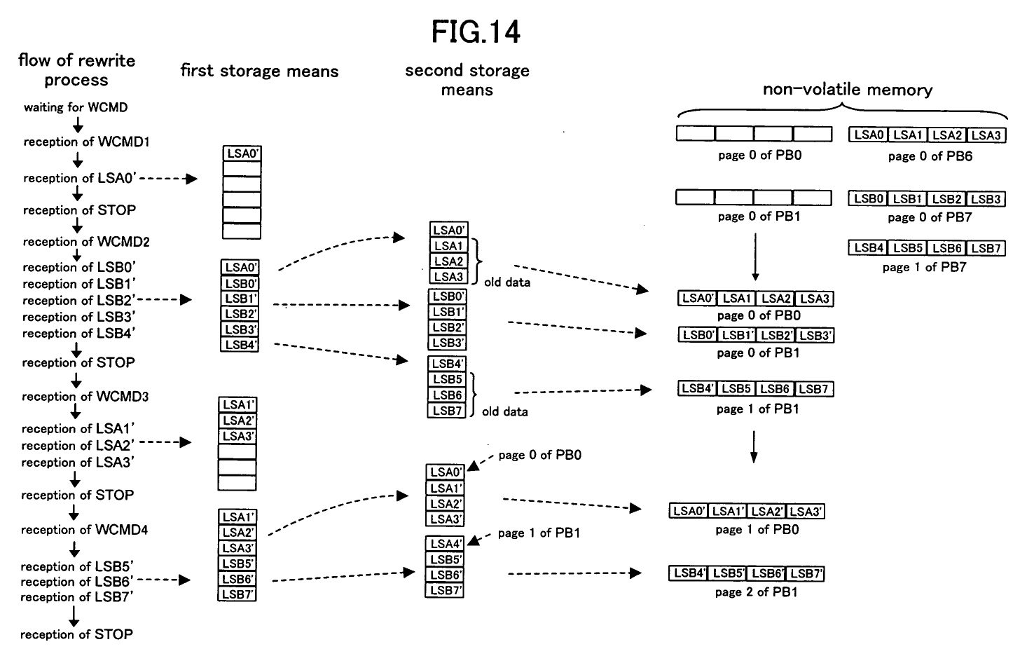

Here, an exemplary process executed by the data processing apparatus of Japanese Unexamined Patent Application Publication No. 2002-123430 will be described with reference to FIG. 14. Here, a first temporary storage means holds six sectors of data, a second temporary storage means holds four sectors of data corresponding to one page of a non-volatile memory, and an access apparatus transfers a WCMD four times. Also, as in the embodiment of the present invention, the non-volatile memory has a plurality of physical blocks, data is written on a page-by-page basis, and one page includes four sectors. The first WCMD is represented by WCMD1, the next WCMD is represented by WCMD2, the still next WCMD is represented by WCMD3, and the final WCMD is represented by WCMD4. It is assumed that, when the data processing apparatus receives WCMD1, old data LSA0 to LSA3 are already stored in page 0 of a physical block PB6 in the non-volatile memory, old data LSB0 to LSB3 are already stored in page 0 of a physical block PB7, and old data LSB4 to LSB7 are already stored in page 1 of the physical block PB7. It is also assumed that new data LSA0′ to LSA3′, which are transferred from an access apparatus, are written into page 0 of a physical block PB0, and similarly, new data LSB0′ to LSB7′ having different write addresses, which are transferred from the access apparatus, are written into page 0 and page 1 of a physical block PB1. The physical blocks PB0 and PB1 are erased, or changed to a state in which new data can be written after old data is erased, by the time when the new data LSA0′ to LSA3′ or LSB0′ to LSB7′ are written.

As illustrated in FIG. 14, after receiving WCMD1, the data processing apparatus receives and writes data having a logical sector number 0 (LSA0′) into the first temporary storage means.

Next, when receiving WCMD2, the data processing apparatus receives and writes the data LSB0′ to LSB4′ into the first temporary storage means. Thereby, the first temporary storage means is full of data, so that all data in the first temporary storage means are written into the non-volatile memory. Initially, the data processing apparatus reads the data LSA0 to LSA3 stored in page 0 of the physical block PB6, which are old data in the non-volatile memory, into the second temporary storage means, in order to write the data LSA0′ into the non-volatile memory. Thereafter, the data LSA0 in the second temporary storage means is overwritten with the data LSA0′ in the first temporary storage means. Thereby, a full page of data in which only the data LSA0′ is rewritten into the second temporary storage means is obtained. Therefore, the page of data is written into page 0 of the physical block PB0 of the non-volatile memory. In a similar manner, data LSB0′ to LSB3′ are written into page 0 of the physical block PB1. Also, in a similar manner, the data LSB4′ is written together with the old data LSB5 to LSB7 (involving he old data LSB5 to LSB7) into page 1 of the physical block PB1.

Next, the data processing apparatus receives WCMD3 and WCMD4, and stores the data LSA1′ to LSA3′ and the data LSB5′ to LSB7′ into the first temporary storage means. Thereby, the first temporary storage means is full, and as is similar to that described above, writing into the non-volatile memory is executed. In this case, neither the data LSA1′ to LSA3′ nor the data LSB5′ to LSB7′ reach a full page, and therefore, the data LSA0′ of page 0 of the physical block PB0 and the data LSB4′ of page 1 of the physical block PB1, which are previously written, are read into the second temporary storage means. Thereafter, the data LSA0′ to LSA3′ are written into the next page, i.e., page 1 of the physical block PB0, and the data LSB4′ to LSB7′ are written into page 2 of the physical block PB1.

The rewrite process of FIG. 6 and the rewrite process of FIG. 14 will be compared with each other. In the rewrite process of FIG. 14, an area of five pages of the non-volatile memory is used, and a process of writing a page of data into the non-volatile memory (page write) is executed five times. A process of reading a page of data from the non-volatile memory into the second temporary storage means is also executed five times. In the rewrite process of FIG. 6 of the present invention, an area of three pages of the non-volatile memory 130 is used, and a process of writing a page of data into the non-volatile memory 130 (page write) is executed three times. When the non-volatile storage device 100 of the present invention is used, the number of times of execution of a save process, i.e., a process of reading a page of data from the non-volatile memory into the second temporary storage means, is smaller than when the conventional data processing apparatus of Japanese Unexamined Patent Application Publication No. 2002-123430 is used, resulting in an increase in speed with which data is rewritten.

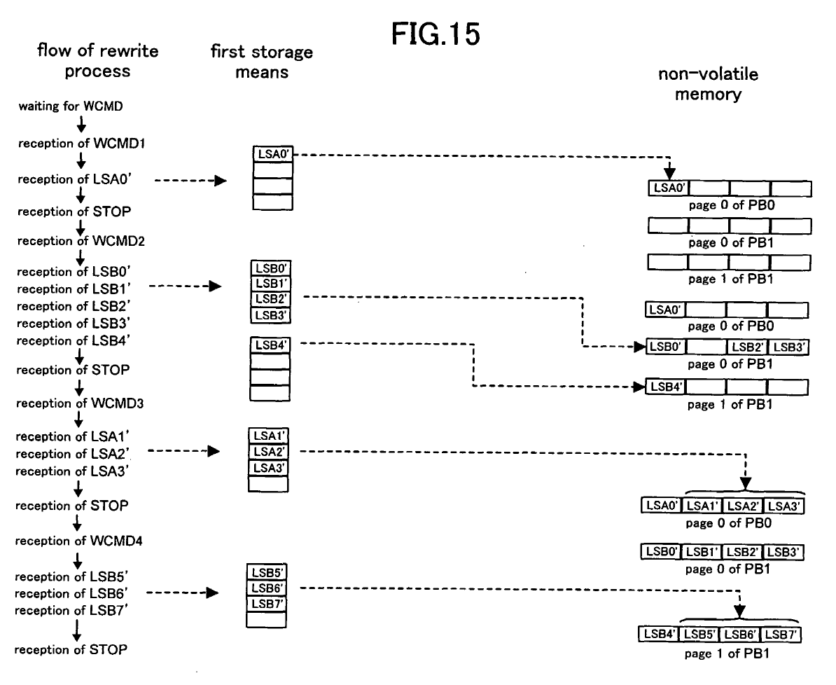

Next, an exemplary process of a data processing apparatus comprising a first temporary storage means for holding data, in which, when a single data reception operation is ended and when the first temporary storage means is full, data is written from the first temporary storage means into a non-volatile memory, will be described with reference to FIG. 15. Note that the rewrite processes of FIGS. 6 and 14 are executed when old data is stored in the non-volatile memory. Here, a case where old data is not stored in the non-volatile memory will be described. It is also assumed that the first temporary storage means has a capacity of four sectors. The first WCMD is represented by WCMD1, the next WCMD is represented by WCMD2, the still next WCMD is represented by WCMD3, and the final WCMD is represented by WCMD4.

Initially, after receiving WCMD1, the data processing apparatus receives data having a logical sector number 0 (LSA0′) and writes the data into the first temporary storage means. Thereafter, the data processing apparatus writes the data LSA0′ from the first temporary storage means into a sector storage location corresponding to the data LSA0′ of a physical block PB0 of the non-volatile memory.

Next, after receiving WCMD2, the data processing apparatus receives and writes data LSB0′ to LSB4′ into the first temporary storage means. Thereafter, the data processing apparatus writes the data LSB0′ to LSB3′ from the first temporary storage means into sector storage locations corresponding to the data LSB0′ to LSB3′ of a physical block PB1 of the non-volatile memory. Next, the data processing apparatus writes the data LSB4′ from the first temporary storage means to a sector storage location corresponding to the data LSB4′ of the physical block PB1 of the non-volatile memory.

Next, after receiving WCMD3, the data processing apparatus receives and writes data LSA1′ to LSA3′ into the first temporary storage means. Thereafter, the data processing apparatus writes the data LSA1′ to LSA3′ from the first temporary storage means into sector storage locations corresponding to the data LSA1′ to LSA3′ of the physical block PB0 of the non-volatile memory.

Finally, after receiving WCMD4, the data processing apparatus receives and writes data LSB5′ to LSB7′ into the first temporary storage means. Thereafter, the data processing apparatus writes the data LSB5′ to LSB7′ from the first temporary storage means into sector storage locations corresponding to the data LSB5′ to LSB7′ of the physical block PB0 of the non-volatile memory.

In the rewrite process of FIG. 15, an area of three pages of the non-volatile memory is used, and a process of writing a page of data into the non-volatile memory 130 (page write) is executed five times. In this case, the write speed is faster than that of the rewrite process of FIG. 14, but is slower than that of the rewrite process of the present invention of FIG. 6.

In the rewrite process of FIG. 15, data is written into different storage locations in the same page in a time division manner, i.e., so-called division writing is executed. Whereas some memories, such as a binary NAND flash memory and the like, can execute division writing, other memories, such as a multilevel NAND flash memory and the like, do not guarantee the reliability when division writing is executed. In other words, the division writing as illustrated in FIG. 14 may be avoided in order to secure the reliability of the memory card.

Although it has been assumed in this embodiment that the first storage section 122 has a capacity of four sectors and the second storage section 123 has a capacity of five sectors, the capacities of the storage sections (memories) are not limited to these. Also, the formats of the storage sections and the non-volatile memory are not limited to those of this embodiment.

Also, it has been assumed that, in the non-volatile storage device 100 of this embodiment, data in the second storage section 123 is managed in units of sectors. However, by causing data in the second storage section 123 to be managed in units of pages which are units for writing the non-volatile memory 130, the data management of the second storage section 123 may be simplified.

Also, in this embodiment, the non-volatile storage device 100 is configured so that, when data is read from the non-volatile memory 130 by the access apparatus 110, the data is directly transferred from the non-volatile memory 130 to the first storage section 122 and is then output to the access apparatus 110. Therefore, the number of times of rewriting of data is smaller than when data is output via the second storage section 123. The reduction of the number of times of rewriting is particularly important when a non-volatile memory, such as an FeRAM or the like, is used as the second storage means.

### Embodiment 2

A non-volatile storage device 100 according to Embodiment 2 of the present invention has the same basic configuration as that of the non-volatile storage device 100 of Embodiment 1, except for the operation.

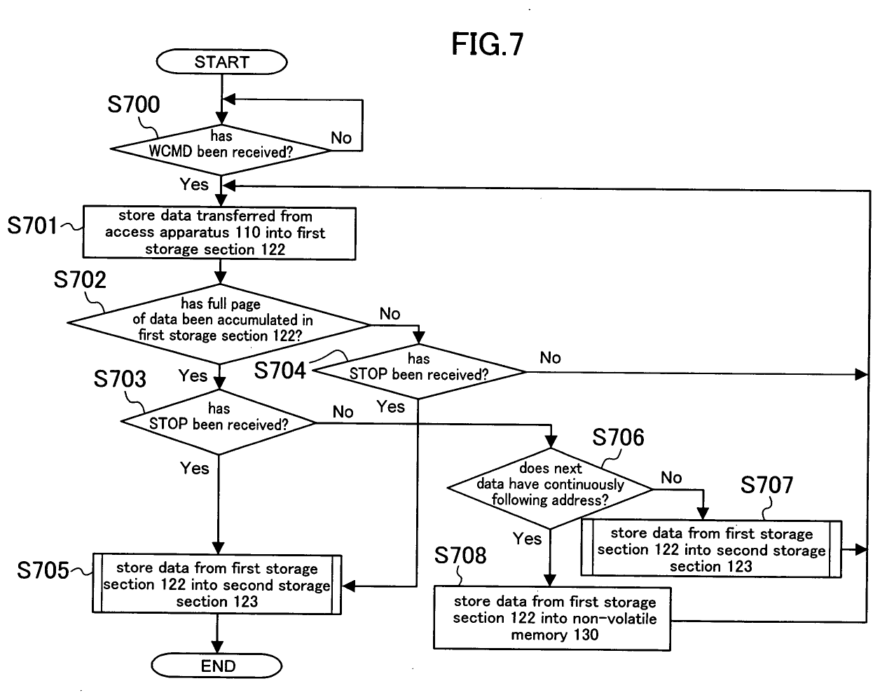

Hereinafter, an operation of the non-volatile storage device 100 of Embodiment 2 of the present invention will be described with reference to FIG. 7.

(S700) The non-volatile storage device 100 goes to a state in which it waits for a data write command (hereinafter referred to as a WCMD) from the access apparatus 110. When receiving the WCMD from the access apparatus 110, the non-volatile storage device 100 goes to a process of (S701).

(S701) When a sector of data and the logical address of the data are transferred (transmitted) from the access apparatus 110, the CPU section 121 stores a value of the transferred logical address into a register of the CPU section 121, and writes the data into the first storage section 122.

(S702) The CPU section 121 determines whether or not the amount of data to be stored into the same page of the non-volatile memory 130, which is accumulated in the first storage section 122, has reached a full page. If the result of the determination is positive, the write process goes to a process of (S703). If the result of the determination is negative, the write process goes to a process of (S704).

(S703) The CPU section 121 determines whether or not a STOP signal indicating the end of data transfer has been input from the access apparatus 110 to the non-volatile storage device 100. When the result of the determination is positive, the non-volatile storage device 100 goes to a process of (S705). When the result of the determination is negative, the non-volatile storage device 100 goes to a process of (S706).

(S704) The CPU section 121 determines whether or not a STOP signal indicating the end of data transfer has been input from the access apparatus 110 to the non-volatile storage device 100. When the result of the determination is positive, the non-volatile storage device 100 goes to a process of (S705). When the result of the determination is negative, the non-volatile storage device 100 returns to the process of (S701).

(S705) The CPU section 121 writes all data held in the first storage section 122 into the second storage section 123, and ends the write process.

(S706) The CPU section 121 determines whether or not the logical address of data which is input from the access apparatus 110 to the non-volatile storage device 100, following the full page of data in the first storage section 122, has a logical address continuous to that of the full page of data in the first storage section 122. If the result of the determination is negative, the non-volatile storage device 100 goes to a process of (S707). If the result of the determination is positive, the non-volatile storage device 100 goes to a process of (S708).

(S707) The CPU section 121 writes the full page of data in the first storage section 122 together with address information about the data into the second storage section 123, and returns to the process of (S701).

(S708) The CPU section 121 writes the full page of data from the first storage section 122 into an area of one page of a predetermined physical block of the non-volatile memory 130.

When the non-volatile storage device 100 receives a plurality of sectors of data after receiving a WCMD and until receiving a STOP signal, the processes of (S701), (S707) and (S708) and the determinations of (S703), (S704) and (S706) are repeated every time a sector of data is received, until a STOP signal is received.

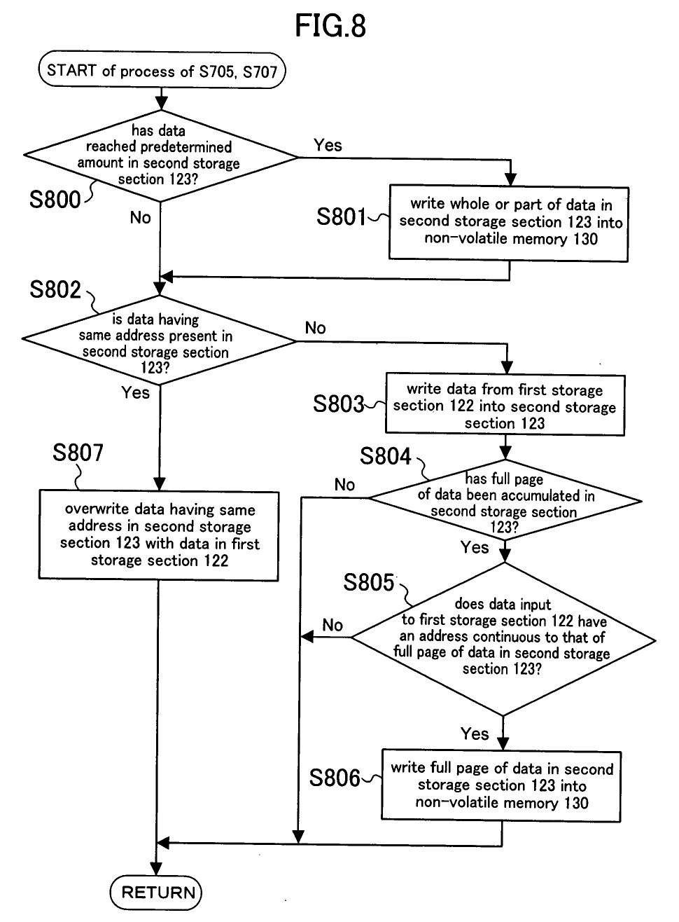

Next, the processes of (S705) and (S707) will be described in detail with reference to FIG. 8.

In each of (S705) and (S707), when a plurality of sectors of data are written from the first storage section 122 into the second storage section 123, processes of (S800) to (S807) are repeated for each sector of data.

(S800) The CPU section 121 determines whether or not the amount of data in the second storage section 123 has reached a predetermined amount. When the result of the determination is positive, the non-volatile storage device 100 goes to a process of (S801). When the result of the determination is negative, the non-volatile storage device 100 goes to a process of (S802).

(S801) The CPU section 121 writes the whole or a part of data in the second storage section 123 into the non-volatile memory 130.

(S802) The CPU section 121 determines whether or not data having the same address as that of the data in the first storage section 122 to be written into the second storage section 123 is held (stored) in the second storage section 123. If the result of the determination is negative, the non-volatile storage device 100 goes to a process of (S803). If the result of the determination is positive, the non-volatile storage device 100 goes to a process of (S807).

(S803) The CPU section 121 writes the data from the first storage section 122 into a free area of the second storage section 123.

(S804) The CPU section 121 determines whether or not the amount of data to be stored into the same page of the non-volatile memory 130, which is accumulated in the second storage section 123, has reached a full page. If the result of the determination is positive, the non-volatile storage device 100 goes to a process of (S805). If the result of the determination is negative, the non-volatile storage device 100 returns to the process of FIG. 7.

(S805) The CPU section 121 determines whether or not the address of the full page of data in the second storage section 123 is continuous to the address of data which is input from the access apparatus 110 to the non-volatile storage device 100 and is stored into the first storage section 122, following the full page of data, by comparing both the addresses. If the result of the determination is positive, the non-volatile storage device 100 goes to a process of (S806). If the result of the determination is negative, the non-volatile storage device 100 returns to the process of FIG. 7.

(S806) The CPU section 121 writes the full page of data in the second storage section 123 into the non-volatile memory 130.

(S807) The CPU section 121 overwrites data at the above-described same address in the second storage section 123 with the data in the first storage section 122, and returns to the process of FIG. 7.

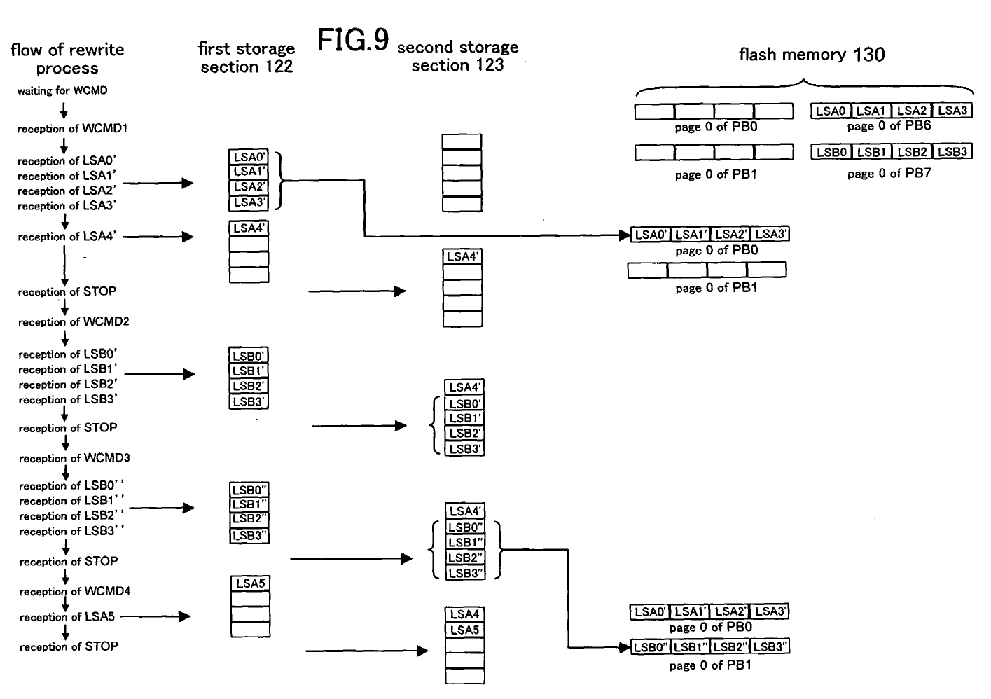

Next, an exemplary process executed by the non-volatile storage device 100 of this embodiment will be described with reference to FIG. 9.

In the example of FIG. 9, as is similar to the example of FIG. 6, the first storage section 122 holds data having an amount corresponding to a page (i.e., four sectors) of the non-volatile memory 130, the second storage section 123 holds five sectors of data, and a WCMD is transferred from the access apparatus 110 four times. The first WCMD is represented by WCMD1, the next WCMD is represented by WCMD2, the still next WCMD is represented by WCMD3, and the final WCMD is represented by WCMD4. It is assumed that, when the non-volatile storage device 100 receives WCMD1, old data LSA0 to LSA3 are already stored in page 0 of the physical block PB6 in the non-volatile memory 130, and old data LSB0 to LSB3 are already stored in page 0 of the physical block PB7.

After receiving WCMD1, the non-volatile storage device 100 receives data (LSA0′ to LSA4′) having a logical sector number 0 sequentially, and causes the first storage section 122 to temporarily hold the data LSA0′ to LSA3′. Next, the CPU section 121, when confirming that data (LSA4′) having a continuously following address has been input to the non-volatile storage device 100, but not receiving a STOP signal (transfer end signal), writes the data LSA0′ to LSA3′ into page 0 of the physical block PB0 of the non-volatile memory 130, and causes the first storage section 122 to hold the data LSA4′. Note that a plurality of first storage sections 122 may be prepared or the capacity of the first storage section 122 may be increased so that the data LSA4′ is held in the first storage section 122 before the data LSA0′ to LSA3′ are written into the non-volatile memory 130. When a STOP signal is transferred after the data LSA4′ is transferred to the first storage section 122, the CPU section 121 writes the data LSA4′ into the second storage section 123.

Next, after receiving WCMD2, the non-volatile storage device 100 receives and writes data LSB0′ to LSB3′ into the first storage section 122. Thereafter, the CPU section 121, when confirming that a STOP signal has been received, writes the data (LSB0′ to LSB3′) of the first storage section 122 into the second storage section 123.

Further, after WCMD3, data LSB0″ to LSB3″ obtained by updating LSB0′ to LSB3′ are transferred from the access apparatus 110 to the non-volatile storage device 100. Thereafter, the CPU section 121, when confirming that a STOP signal has been transferred to the non-volatile storage device 100, writes the data (LSB0″ to LSB3″) from the first storage section 122 into the second storage section 123. In this case, the CPU section 121 checks address information about each data in the second storage section 123, and when confirming the presence of data (LSB0′ to LSB3′) having the same address, overwrites the old data (LSB0′ to LSB3′) with the new LSB0″ to LSB3″ at locations where the old data (LSB0′ to LSB3′) have been stored.

Finally, after WCMD4 is input to the non-volatile storage device 100, data LSA5 is held by the first storage section 122. Thereafter, when a STOP signal is input to the non-volatile storage device 100, the CPU section 121 writes the data LSA5 into the second storage section 123. In this case, since the second storage section 123 has already been full, the CPU section 121 writes a full page of data LSB0″ to LSB3″ into page 0 of the physical block PB1 of the non-volatile memory 130 to secure a space in the second storage section 123 before writing the data LSA5 into the second storage section 123.

In the non-volatile storage device 100 of this embodiment, if a page of data to be stored into the same page of the non-volatile memory 130 is data which has the possibility of being repeatedly and frequently written into the same logical address, but not continuous data having an amount exceeding one page, the data is temporarily written into the second storage section 123, but not is directly written from the first storage section 122 to the non-volatile memory 130. Thereby, the occurrence of garbage collection, which slows the write speed of the non-volatile storage device 100, is reduced. In addition, the number of times of rewriting of the non-volatile memory 130 is reduced. Therefore, the data write speed is increased, leading to extension of the life of the non-volatile memory.

Also in this embodiment, in the second storage section 123, data having the same logical address as that of write data to be written from the first storage section 122 to the second storage section 123 is overwritten with the write data. Therefore, the limited area of the second storage section 123 can be effectively utilized.

Also, in this embodiment, although the second storage section 123 has a capacity of five sectors, a second storage section 123 which can store a larger amount of data may be used. Since data having the same logical address as that of write data to be written from the first storage section 122 to the second storage section 123 is overwritten with the write data in the second storage section 123, the efficiency of writing can be further increased by using a larger-capacity second storage section 123.

Also, in the non-volatile storage device 100 of this embodiment, data is managed in units of sectors in the second storage section 123. Alternatively, in the second storage section 123, data may be managed in units of pages, which are units for writing of the non-volatile memory 130, thereby simplifying the data management of the second storage section 123.

### Embodiment 3

A non-volatile storage device 100 according to Embodiment 3 of the present invention has the same basic configuration as that of the non-volatile storage device 100 of Embodiment 1, except for the operation.

Also, the non-volatile storage device 100 of this embodiment comprises an address history management section in the CPU section 121. The address history management section stores a history of logical addresses externally input to the non-volatile storage device 100.

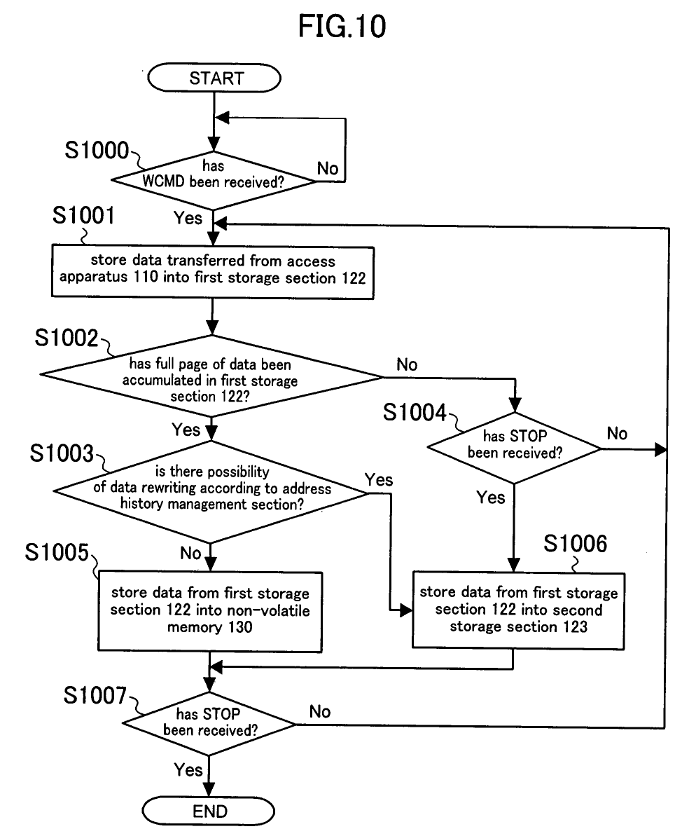

The operation of the non-volatile storage device 100 of this embodiment is different from that of the non-volatile storage device 100 of Embodiment 1 in that processes of (S1000) to (S1007) of FIG. 10 are executed instead of the processes of (S400) to (S406) of FIG. 4.

Hereinafter, an operation of the non-volatile storage device 100 of Embodiment 3 of the present invention will be described with reference to FIG. 10.

(S1000) The non-volatile storage device 100 goes to a state in which it waits for a data write command (hereinafter referred to as a WCMD) from the access apparatus 110. When receiving the WCMD from the access apparatus 110, the non-volatile storage device 100 goes to a process of (S1001).

(S1001) When data and the logical address of the data are transferred (transmitted) from the access apparatus 110, the CPU section 121 stores a value of the transferred logical address into a register of the CPU section 121, and writes the data into the first storage section 122.

(S1002) The CPU section 121 determines whether or not the amount of data to be stored into the same page of the non-volatile memory 130, which is accumulated in the first storage section 122, has reached a full page. If the result of the determination is positive, the non-volatile storage device 100 goes to a process of (Si 003). If the result of the determination is negative, the non-volatile storage device 100 goes to a process of (S1004).

(S1003) The CPU section 121 determines whether or not there is a possibility that the full page of data in the first storage section 122 is to be rewritten, based on logical addresses (address information) stored in the address history management section, i.e., the history of logical addresses (address information) of data which have been so far received by the non-volatile storage device 100. The possibility that data is to be rewritten is a possibility that, after the data is input to the non-volatile storage device 100, data having the same logical address as that of that data is input as write data. If the result of the determination is negative, the non-volatile storage device 100 goes to a process of (S1005). If the result of the determination is positive, the non-volatile storage device 100 goes to a process of (S1006).

(S1004) The CPU section 121 determines whether or not a STOP signal indicating the end of data transfer has been input from the access apparatus 110 to the non-volatile storage device 100. If the result of the determination is positive, the non-volatile storage device 100 goes to the process of (S1006). If the result of the determination is negative, the non-volatile storage device 100 returns to the process of (S1001).

(S1005) The CPU section 121 writes the full page of data from the first storage section 122 into one page of a predetermined physical block of the non-volatile memory 130.

(S1006) The CPU section 121 writes data to be stored into the same page of the non-volatile memory 130, which is accumulated in the first storage section 122, into the second storage section 123.

(S1007) The CPU section 121 determines whether or not a signal indicating the end of data transfer has been input from the access apparatus 110 to the non-volatile storage device 100. If the result of the determination is positive, the non-volatile storage device 100 ends the write process. If the result of the determination is negative, the non-volatile storage device 100 goes to the process of (S1001).

The determination in (S1003) of whether or not there is the possibility of rewriting of the full page of data in the first storage section 122, is executed based on whether or not the full page of data in the first storage section 122 is data included in continuous data which is input continuously into the non-volatile storage device 100 in an amount corresponding to a predetermined number of sectors or more. In other words, if the full page of data is included in continuous data having an amount corresponding to the predetermined number of sectors or more, it is determined that there is not the possibility of rewriting. If the full page of data is not included in the continuous data, it is determined that there is the possibility of rewriting.

In (S1006), the process of (S405) of Embodiment 1 (the processes of (S500) to (S504)) or the process of (S705) of Embodiment 2 (the processes of (S800) to (S806)) is executed.

When the non-volatile storage device 100 receives a plurality of sectors of data after receiving a WCMD and until receiving a STOP signal, the processes of (S1001), (S1005) and (S1006) and the determinations of (S1002) to (S1004) and (S1007) are repeated every time a sector of data is received, until a STOP signal is received.

Note that the logical address history stored in the address history management section is data which is used so as to determine whether or not the full page of data is included in continuous data which is input continuously into the non-volatile storage device 100 in an amount corresponding to a predetermined number of sectors or more. For example, the history is data, such as the start address and the end address of continuous data, the start address of continuous data and the number of sectors continuously written, a flag indicating whether or not each data is included in one or more pages of continuous data, or the like.

Thus, the present invention has been described with reference to FIG. 10. By determining whether data is continuous data to be continuously written, such as image data, music data or the like, or data to be repeatedly written into the same address, such as system information, management information or the like, based on an address history written in the address history management section, continuous data can be more efficiently written into the non-volatile memory, and data to be repeatedly written into the same address can be more efficiently written into the second storage section 123. Thereby, the efficiency of writing of data into the non-volatile memory 130 can be improved.

Note that the determination in (S1003) may be executed based on whether or not data having the same logical address as that of the full page of data has been repeatedly input. Specifically, when it is determined based on information stored in the address history management section that data having the same logical address as that of the full page of data has been input to the non-volatile storage device 100 a predetermined number of times or more, it may be determined that there is the possibility of rewriting. If otherwise, it may be determined that there is not the possibility of rewriting.

### Embodiment 4

A non-volatile storage device 100 according to Embodiment 4 of the present invention has the same basic configuration as that of the non-volatile storage device 100 of Embodiment 1, except for the operation.

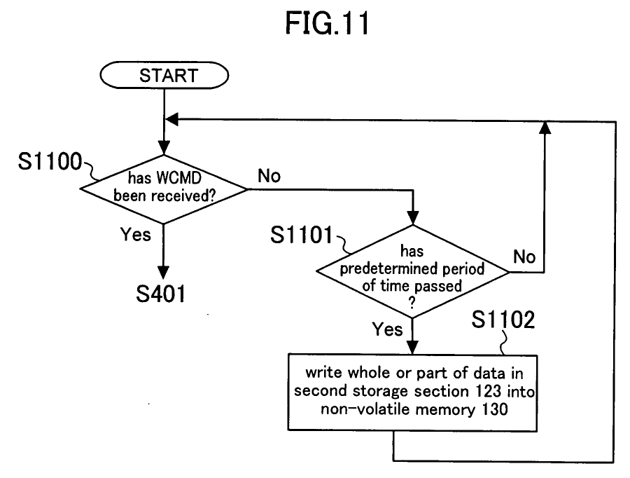

Hereinafter, an operation of the non-volatile storage device 100 of Embodiment 4 of the present invention will be described with reference to FIG. 11.

The operation of the non-volatile storage device 100 of this embodiment is different from that of the non-volatile storage device 100 of Embodiment 1 in that processes of (S1100) to (S102) described below are executed instead of the process of (S400) of FIG. 4.

(S1100) The non-volatile storage device 100 goes to a state in which it waits for a data write command (hereinafter referred to as a WCMD) from the access apparatus 110. When receiving the WCMD from the access apparatus 110, the non-volatile storage device 100 goes to the process of (S401). When not receiving the WCMD from the access apparatus 110, the non-volatile storage device 100 goes to a process of (SI 101).

(S1101) When a predetermined period of time has passed since the WCMD was previously received, the CPU section 121 goes to a process of (S1102). When otherwise, the CPU section 121 returns to the process of (S1100).

(S1102) The CPU section 121 writes the whole or a part of data in the second storage section 123 into the non-volatile memory 130.

As described above, in the non-volatile storage device 100 of this embodiment, when there is no access from the access apparatus 110 to the non-volatile storage device 100 for a predetermined period of time, the whole or a part of data stored in the second storage section 123 is transferred to the non-volatile memory 130. Therefore, when next data arrives from the access apparatus 110, the whole of a part of the storage area (memory space) of the second storage section 123 is free. Thus, the second storage section 123 is effectively utilized, so that the capacity of the second storage section can be reduced. Thereby, it is possible to reduce the chip size or the like, leading to a reduction in cost.

### Embodiment 5

A non-volatile storage device 100 according to Embodiment 5 of the present invention has the same basic configuration as that of the non-volatile storage device 100 of Embodiment 1, except for the operation.

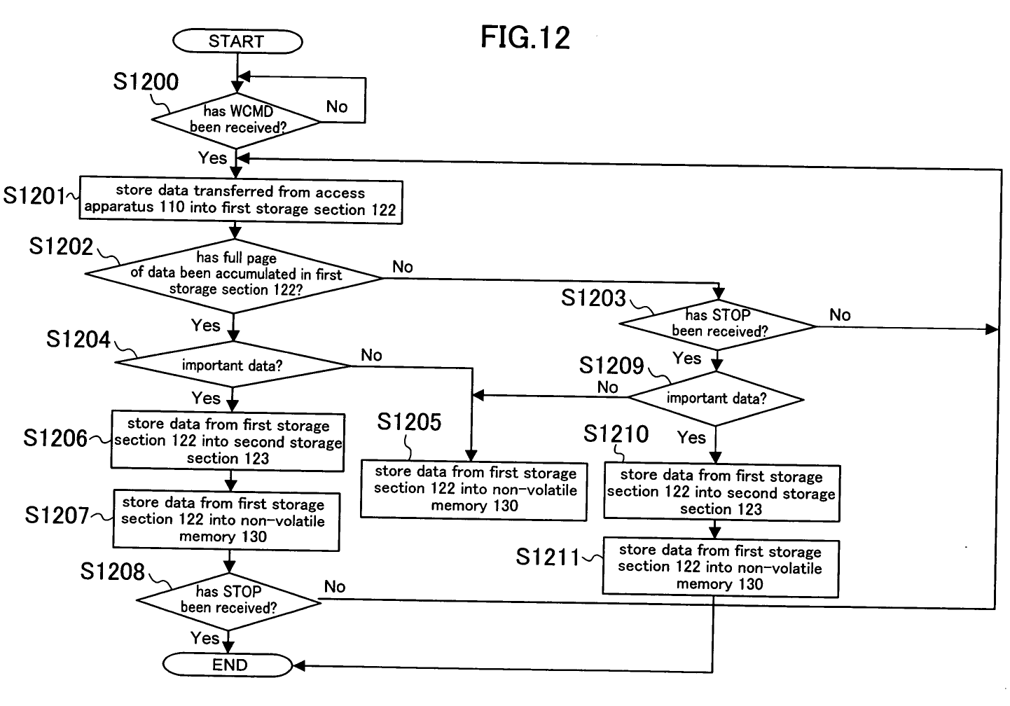

Hereinafter, an operation of the non-volatile storage device 100 of Embodiment 5 of the present invention will be described with reference to FIG. 12.

(S1200) The non-volatile storage device 100 goes to a state in which it waits for a data write command (hereinafter referred to as a WCMD) from the access apparatus 110.

(S1201). When data and the logical address of the data are transferred (transmitted) from the access apparatus 110, the CPU section 121 stores a value of the transferred logical address into a register of the CPU section 121, and writes the data into the first storage section 122 (or causes the first storage section 122 to hold the data).

(S1202) The CPU section 121 determines whether or not the amount of data to be stored into the same page of the non-volatile memory 130, which is accumulated in the first storage section 122, has reached a full page. If the result of the determination is positive, the non-volatile storage device 100 goes to a process of (S1204). If the result of the determination is negative, the non-volatile storage device 100 goes to a process of (S1203).

(S1203) The CPU section 121 determines whether or not a STOP signal indicating the end of data transfer has been input from the access apparatus 110 to the non-volatile storage device 100. When the result of the determination is positive, the non-volatile storage device 100 goes to a process of (S1209). When the result of the determination is negative, the non-volatile storage device 100 returns to the process of (S1201).

(S1204) The CPU section 121 determines whether or not the full page of data determined in (S1202) is important data. Here, if the full page of data determined in

(S1202) is any of FAT (File Allocation Tables), address information, and security information, the data is determined as important data. The determination is executed using the data itself, the logical address of the data, a write command input from the access apparatus 110, or the like. If the result of the determination is positive, the non-volatile storage device 100 goes to a process of (S1206). If the result of the determination is negative, the non-volatile storage device 100 goes to a process of (S1205). Note that the determination of whether or not the data is important data may be executed per full page of data determined in (S 1202) or per sector of data.

(S1205) The CPU section 121 writes the full page of data determined in (S1202) into an area of one page of a predetermined physical block of the non-volatile memory 130.

(S1206) (S1207) The CPU section 121 causes the second storage section 123 to hold the full page of data determined in (S1202), and writes the full page of data determined in (S1202) into an area of one page of a predetermined physical block of the non-volatile memory 130.

(S1208) The CPU section 121 determines whether or not a STOP signal indicating the end of data transfer has been input from the access apparatus 110 to the non-volatile storage device 100. When the result of the determination is positive, the non-volatile storage device 100 ends the write process. When the result of the determination is negative, the non-volatile storage device 100 returns to the process of (S1201).

(S1209) The CPU section 121 determines whether or not the data held in the first storage section 122 is important data. If the result of the determination is positive, the non-volatile storage device 100 goes to a process of (S1210). If the result of the determination is negative, the non-volatile storage device 100 goes to the process of (S1205).

(S1210) (S1211) The CPU section 121 causes the second storage section 123 to hold the data held by the first storage section 122, and writes the data into an area of one page of a predetermined physical block of the non-volatile memory 130.

Note that the important data stored in the second storage section 123 is erased or is handled as invalid data which may be overwritten with new data after the CPU section 121 confirms that the important data has been stored in the non-volatile memory 130.

As described above, in the non-volatile storage device 100 of this embodiment, important data is written into both the second storage section. 123 and the non-volatile memory 130, so that the possibility that data is lost due to an unexpected accident is low. Therefore, the non-volatile storage device 100 is configured so that important data is written into both the second storage section 123 and the non-volatile memory 130, thereby making it possible to improve the reliability of the non-volatile storage device 100.

Also, if a non-volatile memory, such as an FeRAM or the like, is used as the second storage section 123, the possibility that data is lost due to interruption of power supply during writing or the like can be reduced, resulting in a further improvement in the reliability of the non-volatile storage device 100.

Also, if the non-volatile storage device 100 is configured so that, when data is read out from the non-volatile memory 130 by the access apparatus 110, the data is directly transferred from the non-volatile memory 130 to the first storage section 122 and is then output to the access apparatus 110, the number of times of rewriting is smaller than when the non-volatile storage device 100 is configured so that the data is output via the second storage section 123. The reduction of the number of times of rewriting is particularly important when a non-volatile memory, such as an FeRAM or the like, is used as the second storage means.

Although FAT, address management information, and security information are determined as important data in the non-volatile storage device 100 of this embodiment, a portion of the data or other data may be determined as important data. For example, other data such that if it is lost, data in the non-volatile memory 130 can no longer be read, may be determined as important data.

### Embodiment 6

A non-volatile storage device 100 according to Embodiment 6 of the present invention has the same basic configuration as that of the non-volatile storage device 100 of Embodiment 1, except for the operation.

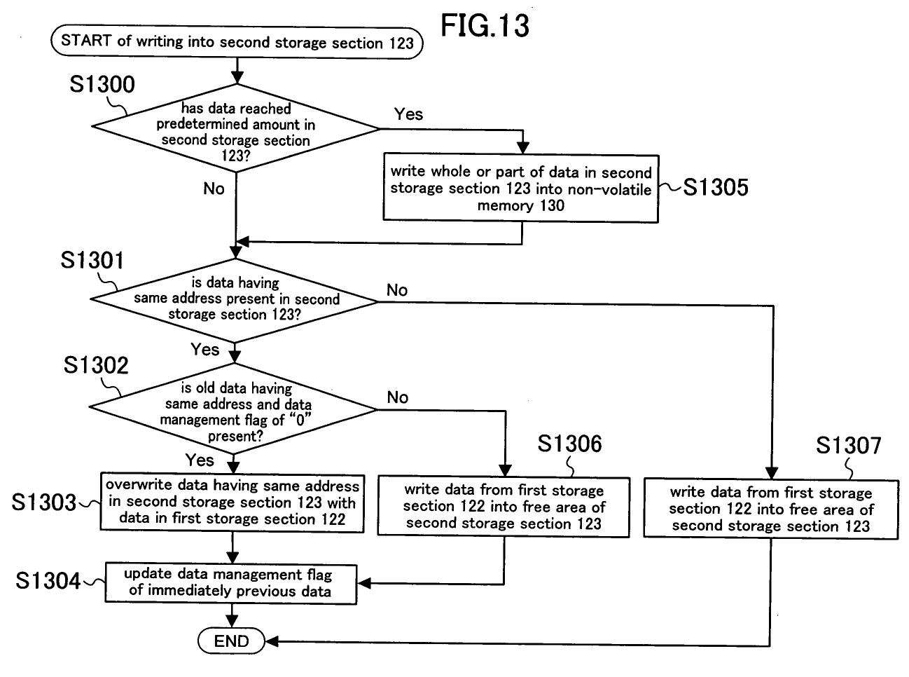

Hereinafter, an operation of the non-volatile storage device 100 of Embodiment 6 of the present invention will be described with reference to FIG. 13.

The operation of the non-volatile storage device 100 of this embodiment is different from that of the non-volatile storage device 100 of Embodiment 1 in that processes of (S 1300) to (S1307) of FIG. 13 are executed instead of the processes of (S500) to (S504) of FIG. 5.

(S1300) The CPU section 121 determines whether or not the amount of data in the second storage section 123 has reached a predetermined amount. If the result of the determination is negative, the non-volatile storage device 100 goes to a process of (S1301). If the result of the determination is positive, the non-volatile storage device 100 goes to a process of (S1305).

(S1301) The CPU section 121 determines whether or not data having the same address as that of write data to be written from the first storage section 122 into the second storage section 123 has been held (stored) in the second storage section 123. If the result of the determination is positive, the non-volatile storage device 100 goes to a process of

(S1302). If the result of the determination is negative, the non-volatile storage device 100 goes to a process of (S1307).

(S1302) The CPU section 121 determines whether a data management flag is “0” or “1” for each data having the same address as that of the data held in the second storage section 123. In other words, it is determined whether each data is latest (the most previously written) data or otherwise (the second most previously or more previously written data). If the flag is “0”, the non-volatile storage device 100 goes to a process of (S1303). If the flag is not “0”, the non-volatile storage device 100 goes to a process of (S1306).

(S1303) The CPU section 121 overwrites data whose data management flag is “0” of the data having the same address, with the write data, and sets the data management flag of the resultant data to be “1”.

(S1304) The CPU section 121 updates the data management flag of data having the same address which has not been overwritten in (S1303) into “0”.

(S1305) The CPU section 121 writes the whole or a part of data in the second storage section 123 into the non-volatile memory 130.

(S1306) The CPU section 121 writes the write data into a free area of the second storage section 123.

(S1307) The CPU section 121 writes the write data into a free area of the second storage section 123, and sets the data management flag of the write data to be “1”.

As described above, in the non-volatile storage device 100 of this embodiment, when the second storage section 123 includes only a piece of data having the same logical address as that of write data from the first storage section 122, the data is not overwritten with the write data. When the second storage section 123 includes two pieces of data having the same logical address as that of write data from the first storage section 122, the older data is overwritten with the write data. Therefore, when the older data is not correctly overwritten with the write data from the first storage section 122 due to an unexpected accident, the remaining later data can be utilized. Thereby, the reliability of data stored in the non-volatile storage device 100 can be improved.

Also, if a non-volatile memory, such as an FeRAM or the like, is used as the second storage section 123, data is protected when an abnorinal operation, such as interruption of power supply or the like, occurs. Therefore, the reliability of the non-volatile storage device 100 can be further improved.

Note that the case where the processes of (S1300) to (S1307) are executed instead of the processes of (S500) to (S504) ((S405)) of Embodiment 1 has been described in this embodiment. Alternatively, the processes of (S1300) to (S1307) may be executed instead of the processes of (S705) and (S707) of Embodiment 2 or the process of (S1006) of Embodiment 3.

### Other Embodiments

Note that the present invention is not limited to the combination of the non-volatile memory (main memory) and the first and second storage means. Various other modifications, such as the use of other non-volatile memories and the like, can be made within the scope of the present invention as set forth in the accompanying claims. These are also within the scope of the present invention:

For example, a non-volatile memory having a format different from that of FIG. 2 of the above-described embodiments may be used. Also, the capacity of the non-volatile memory 130, the first storage section 122 or the second storage section 123 is not limited to that of the above-described embodiments.

In the non-volatile storage device 100 of Embodiment 1, the processes of (S401) to (S403) and the determinations of (S404) and (S406) are executed every time a sector of data is received. Alternatively, the processes and the determinations may be executed every time a plurality of sectors of data are received.

Similarly, in the non-volatile storage device 100 of Embodiment 2, the processes of (S701), (S707) and (S708) and the determinations of (S703), (S704) and (S706) may be executed every time a plurality of sectors of data are received.

Further, similarly, in the non-volatile storage device 100 of Embodiment 3, the processes of (S1001), (S1005) and (S1006) and the determinations of (S1002) to (S1004) and (S1007) may be executed every time a plurality of sectors of data are received.

Also, in the non-volatile storage device 100 of Embodiment 2, in each of (S705) and (S707), when a plurality of sectors of data are written from the first storage section 122 to the second storage section 123, the processes of (S800) to (S807) are repeated per sector of data. Alternatively, the processes of (S800) to (S807) may be executed per a plurality of sectors of data, e.g., per page of data stored in the same page of the non-volatile memory 130.

The present invention is not limited to the above-described embodiments themselves. The parts can be modified and implemented without departing the spirit and scope of the present invention. The parts disclosed in the embodiments can be combined as appropriate into various variations of the present invention. For example, some of all the parts described in the embodiments may be removed. Further, the parts described in the different embodiments may be combined as appropriate.

Specifically, for example, the processes of (S 1100) to (SI 102) of Embodiment 4 may be executed instead of the process of (S700) of Embodiment 2, the process of (S1000) of Embodiment 3, or the process of (S1200) of Embodiment 5.

Also in Embodiments 1 to 3, as is similar to Embodiment 5, data in the first storage section 122 may be written into both the non-volatile memory 130 and the second storage section 123, depending on the importance of the data. Specifically, in Embodiment 1, when data in the first storage section 122 is written into the second storage section 123 in (S403), it may be determined whether or not the data in the first storage section 122 is important data. When the data is important data, the data may be written into the second storage section 123 as well as the non-volatile memory 130. Also in Embodiments 2 and 3, when data in the first storage section 122 is written into the second storage section 123 in (S705) or (S1005), it may be determined whether or not the data in the first storage section 122 is important data. When the data is important data, the data may be written into the second storage section 123 as well as the non-volatile memory 130.

The non-volatile storage device, the data storage system, and the data storage method of the present invention have the effect of high-speed data writing, and are useful as a recording medium, a recording system, and the like for portable audio/video apparatuses (e.g., an audio recording and reproduction apparatus, a still image recording and reproduction apparatus, a moving image recording and reproduction apparatus, etc.), portable communication apparatuses (e.g., a mobile telephone, etc.), a computer which uses a non-volatile memory, such as a flash memory or the like, as a main memory, and an in-vehicle terminal..

What is claimed is:

1. A non-volatile storage device comprising a non-volatile memory into which data is written per unit area, and a memory controller for controlling writing of data into the non-volatile memory, wherein
the memory controller comprises:
a first storage section for holding data input from the outside of the device;
a first control section for writing data which is held by the first storage section and whose amount corresponds to the unit area, into the non-volatile memory in a unit area-by-unit area basis, and writing data which is held by the first storage section and whose amount is less than the unit area, into a second storage section; and
a second control section for writing data held by the second storage section into the non-volatile memory.

2. The non-volatile storage device of claim 1, wherein the first control section, when data input from the outside of the device, following data which is previously held by the first storage section and whose amount corresponds to the unit area, is continuous to the previous data, writes the previous data into the non-volatile memory, and when the following data is not continuous to the previous data, writes the previous data into the second storage section.

3. The non-volatile storage device of claim 1, wherein the first control section, when a signal indicating the end of predetermined data transfer is input from the outside of the device immediately after data which is held by the first storage section and whose amount corresponds to the unit area is input from the outside of the device, writes the data whose amount corresponds to the unit area into the second storage section.

4. The non-volatile storage device of claim 1, further comprising:
an address history management section for storing a history of a logical address of data input from the outside of the device,
wherein the first control section determines whether or not there is a possibility that data which is held by the first storage section and whose amount corresponds to the unit area is to be rewritten, based on the logical address stored in the address history management section, and
the first control section writes the data whose amount corresponds to the unit area into the non-volatile memory when determining that there is not the possibility, and into the second storage section when determining that there is the possibility.

5. The non-volatile storage device of claim 1, wherein, when data whose amount corresponds to the unit area is held by the second storage section, the second control section writes the data whose amount corresponds to the unit area into the non-volatile memory.

6. The non-volatile storage device of claim 1, wherein, when data whose amount corresponds to the unit area is previously held by the second storage section and a logical address of data input from the outside of the device, following the previous data, is continuous to a logical address of the previous data, the second control section writes the previous data into the non-volatile memory.

7. The non-volatile storage device of claim 1, wherein, when data whose amount is larger than or equal to a predetermined amount is held by the second storage section, the second control section writes data held by the second storage section into the non-volatile memory.

8. The non-volatile storage device of claim 1, wherein, when data has not been input from the outside of the device for a predetermined period of time, the second control section writes data held by the second storage section into the non-volatile memory.

9. The non-volatile storage device of claim 1, wherein, when data having the same logical address as that of write data to be written into the second storage section is held by the second storage section, the first control section overwrites the data having the same logical address with the write data.

10. The non-volatile storage device of claim 1, wherein, when a plurality of pieces of data having the same logical address as that of write data to be written into the second storage section are held by the second storage section, the first control section overwrites an oldest one of the plurality of pieces of data having the same logical address with the write data.

11. The non-volatile storage device of claim 1, wherein the first control section writes data which is held by the first storage section and whose amount corresponds to the unit area, into the non-volatile memory and the second storage section, depending on the level of importance of the data whose amount corresponds to the unit area.

12. The non-volatile storage device of claim 1, further comprising:
a read control section for transferring data in the non-volatile memory to the first storage section without via the second storage section, and causing the first storage section to temporarily hold the data before being output to the outside of the device, in response to a data read request from the outside of the device.

13. The non-volatile storage device of claim 1, wherein the second storage section is a non-volatile RAM.

14. The non-volatile storage device of claim 13, wherein the second storage section includes any one of a ferroelectric random access memory, a magnetoresistive random access memory, an ovonic unified memory, and a resistance random access memory.

15. A system for writing and reading data to and from a non-volatile memory into which data is written per predetermined unit amount, comprising:
the non-volatile storage device of claim 1; and
a main computer for reading and writing data to and from the non-volatile storage device.

16. A data storage method in which a memory controller writes data into a non-volatile memory into which data is written per unit area, and into the non-volatile memory, the method comprising:
a data holding step wherein a first storage section holds data input from the outside of the device;
a first control step wherein a first control section writes data which is held by the first storage section and whose amount corresponds to a unit area, into the non-volatile memory, and writes data which is held by the first storage section and whose amount is less than the unit area, into a second storage section; and
a second control step wherein a second control section writes data held by the second storage section into the non-volatile memory.

17. The data storage method of claim 16, wherein, in the first control step, the first control section, when data input from the outside of the device, following data which is previously held by the first storage section and whose amount corresponds to the unit area, is continuous to the previous data, writes the previous data into the non-volatile memory, and when the following data is not continuous to the previous data, writes the previous data into the second storage section.

18. The data storage method of claim 16, wherein, in the first control step, the first control section, when a signal indicating the end of predetermined data transfer is input from the outside of the device immediately after data which is held by the first storage section and whose amount corresponds to the unit area is input from the outside of the device, writes the data whose amount corresponds to the unit area into the second storage section.

19. The data storage method of claim 16, further comprising:
a step wherein an address history management section stores a history of a logical address of data input from the outside of the device,
wherein, in the first control step, the first control section determines whether or not there is a possibility that data which is held by the first storage section and whose amount corresponds to the unit area is to be rewritten, based on the logical address stored in the address history management section, and
the data whose amount corresponds to the unit area is written into the non-volatile memory when it is determined that there is not the possibility, and into the second storage section when it is determined that there is the possibility.
